(19) United States
(12) Patent Application Publication
(10) Pub. No.: US 2026/0002454 A1
(43) Pub. Date: Jan. 1, 2026

(54) ENGINE

(71) Applicant: Kubota Corporation, Osaka (JP)

(72) Inventors: Taro FUKUDA, Ota-shi (JP); Rio MATSUMOTO, Ota-shi (JP); Tsutomu SHIMAZAKI, Ota-shi (JP)

(21) Appl. No.: 19/309,794

(22) Filed: Aug. 26, 2025

Related U.S. Application Data
(63) Continuation of application No. PCT/JP2023/027907, filed on Jul. 31, 2023.

(51) Int. Cl. F01L 9/20; F01L 1/04; F01L 1/46

(52) U.S. Cl. CPC F01L 9/20; F01L 1/04; F01L 1/462

(57) ABSTRACT

An engine in which a decompression mechanism is simplified includes an engine block, a cylinder chamber inside the engine block, and an extension space inside the engine block and extending laterally from the cylinder chamber. The engine also includes a decompression valve installation hole in the engine block in a portion of the extension space, a decompression valve arranged to advance and retreat with respect to the decompression valve installation hole, and a decompression valve advancing/retreating mechanism to cause the decompression valve to perform an advancing/retreating operation.

### CROSS REFERENCE TO RELATED APPLICATIONS

This application is a Continuation application of PCT Application No. PCT/JP2023/027907 filed on Jul. 31, 2023. The entire contents of this application are hereby incorporated herein by reference.

### BACKGROUND OF THE INVENTION

### 1. Field of the Invention

The present invention relates to engines, and particularly, relates to opposed-piston engines.

### 2. Description of the Related Art

Conventionally, opposed-piston engines, as shown in Japanese Patent Application Publication No. 2007-46534 and Japanese Patent Application Publication No. Hei 8-93498, commonly had a structure in which pistons having piston heads that face each other perform linear motion within one cylinder arranged in a horizontal direction. Within this cylinder, the region where the piston heads face each other functions as a combustion chamber, and by an air-fuel mixture undergoing ignition and explosion, the pistons operate, and power is supplied to an external actuator such as a generator.

However, in the engines described in such patent literatures, because the combustion chamber volume is small, achieving a high compression ratio is difficult, and there is also an issue with insulating the combustion chamber. Also, the intake and exhaust valves of conventional opposed-piston engines are directly open to the combustion chamber, and there was a drawback that the volume of the combustion chamber becomes large.

In order to solve such issues, the engine described in Domestic Re-publication of PCT International Application No. WO2013/047878 was invented. In the engine described in Domestic Re-publication of PCT International Application No. WO2013/047878, independent left and right pistons are arranged within a horizontal cylinder so as to face each other. Also, one combustion chamber is formed between the left and right piston heads, communicating with the outside of the horizontal cylinder. Furthermore, in the engine described in Domestic Re-publication of PCT International Application No. WO2013/047878, an extension portion extending laterally from the combustion chamber is formed. In this extension portion, a spark plug is provided.

### SUMMARY OF THE INVENTION

However, in the opposed-piston engines described in the aforementioned patent literatures, there was room for improvement from the viewpoint of optimization of the decompression mechanism. Specifically, in the opposed-piston engine described in Domestic Re-publication of PCT International Application No. WO2013/047878, a centrifugal decompression mechanism was arranged. However, because the centrifugal decompression mechanism is configured to change its form according to centrifugal force, there was an issue that its mechanical configuration itself is complicated. Furthermore, when arranging a plurality of cylinder chambers in an engine, because it is necessary to arrange a centrifugal decompression mechanism for each cylinder chamber, there was an issue that the entire engine becomes further complicated and enlarged.

Example embodiments of the present invention provide engines in each of which a decompression mechanism is simplified.

An engine according to an example embodiment of the present invention includes an engine block, a cylinder chamber inside the engine block, an extension space inside the engine block and extending outward from the cylinder chamber, a decompression valve installation hole in the engine block in a portion of the extension space, a decompression valve arranged to advance and retreat with respect to the decompression valve installation hole, a decompression valve advancing/retreating mechanism to cause the decompression valve to perform an advancing/retreating operation, a first engine portion, and a second engine portion, wherein the first engine portion includes a first piston, a first connecting rod, and a first crankshaft, the second engine portion includes a second piston, a second connecting rod, and a second crankshaft, the first piston and the second piston oppose each other inside the cylinder chamber, the extension space extends from a portion of the cylinder chamber sandwiched by the first piston and the second piston, in a direction orthogonal to a direction in which the first piston and the second piston reciprocate, the decompression valve advancing/retreating mechanism includes a spring and an actuator, the spring is arranged to urge the decompression valve to close the decompression valve installation hole, and the actuator is arranged to urge the decompression valve to open the decompression valve installation hole.

Also, in an engine according to an example embodiment of the present invention, the cylinder chamber includes a first cylinder chamber and a second cylinder chamber, the extension space includes a first extension space in the first cylinder chamber and a second extension space in the second cylinder chamber, the decompression valve installation hole includes a first decompression valve installation hole in the engine block in a portion of the first extension space and a second decompression valve installation hole in the engine block in a portion of the second extension space, the decompression valve includes a first decompression valve arranged to advance and retreat with respect to the first decompression valve installation hole and a second decompression valve arranged to advance and retreat with respect to the second decompression valve installation hole, the spring includes a first spring arranged to apply an urging force to the first decompression valve and a second spring arranged to apply an urging force to the second decompression valve, the first decompression valve closes the first decompression valve installation hole by being urged by the first spring, and opens the first decompression valve installation hole by being pressed by the actuator, and the second decompression valve closes the second decompression valve installation hole by being urged by the second spring, and opens the second decompression valve installation hole by being pressed by the actuator.

Also, in an engine according to an example embodiment of the present invention, the decompression valve advancing/retreating mechanism includes a shaft rotatable by the actuator, a cam connected to the shaft so as to be relatively non-rotatable, and a rocker arm to rotate by abutting the cam, and a first side of the rocker arm abuts the cam, and a second side abuts the first decompression valve and the second decompression valve.

Also, in an engine according to an example embodiment of the present invention, the actuator is a linear actuator.

An engine according to an example embodiment of the present invention includes an engine block, a cylinder chamber inside the engine block, an extension space inside the engine block and extending laterally from the cylinder chamber, a decompression valve installation hole in the engine block in a portion of the extension space, a decompression valve arranged to advance and retreat with respect to the decompression valve installation hole, and a decompression valve advancing/retreating mechanism to cause the decompression valve to perform an advancing/retreating operation, wherein the decompression valve advancing/retreating mechanism includes a spring and an actuator, and by being urged by the spring, the decompression valve closes the decompression valve installation hole, and by being pressed by the actuator, the decompression valve opens the decompression valve installation hole. According to an engine of an example embodiment of the present invention, by performing closing and opening of the extension space by the decompression valve by the spring and the actuator, the configuration of the decompression valve advancing/retreating mechanism can be simplified, and simplification and miniaturization of the entire engine can be achieved.

Also, in an engine according to an example embodiment of the present invention, the cylinder chamber includes a first cylinder chamber and a second cylinder chamber, the extension space includes a first extension space in the first cylinder chamber and a second extension space in the second cylinder chamber, the decompression valve installation hole includes a first decompression valve installation hole in the engine block in a portion of the first extension space and a second decompression valve installation hole in the engine block in a portion of the second extension space, the decompression valve includes a first decompression valve arranged to advance and retreat with respect to the first decompression valve installation hole and a second decompression valve arranged to advance and retreat with respect to the second decompression valve installation hole, the spring includes a first spring arranged to apply an urging force to the first decompression valve and a second spring arranged to apply an urging force to the second decompression valve, the first decompression valve is urged by the first spring to close the first decompression valve installation hole and is pressed by the actuator to open the first decompression valve installation hole, and the second decompression valve is urged by the second spring to close the second decompression valve installation hole and is pressed by the actuator to open the second decompression valve installation hole. According to an engine of an example embodiment of the present invention, the first decompression valve and the second decompression valve are configured to close the first decompression valve installation hole and the second decompression valve installation hole by the first spring and the second spring respectively attached thereto. Also, the first decompression valve and the second decompression valve are configured to open the first decompression valve installation hole and the second decompression valve installation hole by a common actuator. Therefore, the first decompression valve and the second decompression valve can be made to perform an advancing/retreating operation by a small number of actuators.

Also, in an engine according to an example embodiment of the present invention, the decompression valve advancing/retreating mechanism includes a shaft rotatable by the actuator, a cam connected to the shaft so as to be relatively non-rotatable, and a rocker arm that is rotatable by abutting the cam, and a first side of the rocker arm abuts the cam and a second side abuts the first decompression valve and the second decompression valve. According to an engine of an example embodiment of the present invention, by operating a plurality of decompression valves with one actuator, the configuration of the decompression valve advancing/retreating mechanism can be simplified.

Also, in an engine according to an example embodiment of the present invention, the actuator is a linear actuator. According to an engine of an example embodiment of the present invention, because the decompression valves can be operated in a plurality of cylinder chambers by the linearly operating linear actuator, the configuration of the decompression valve advancing/retreating mechanism and the engine can be simplified.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view showing an engine according to an example embodiment of the present invention.

FIG. 2A is a diagram showing an engine according to an example embodiment of the present invention, and is a perspective view showing a first engine block.

FIG. 2B is a diagram showing an engine according to an example embodiment of the present invention, and is a perspective view showing a second engine block.

FIG. 3A is a diagram showing an engine according to an example embodiment of the present invention, and is a diagram showing a first contact surface of the first engine block.

FIG. 3B is a diagram showing an engine according to an example embodiment of the present invention, and is a diagram showing a second contact surface of the second engine block.

FIG. 4 is a diagram showing an engine according to an example embodiment of the present invention, and is a perspective view showing an engine unit and the like.

FIG. 5 is a diagram showing an engine according to an example embodiment of the present invention, and is a cross-sectional view showing a wall portion of an engine block that forms a cylinder chamber and an extension space.

FIG. 6A is a diagram showing an engine according to an example embodiment of the present invention, and is a perspective view showing a decompression valve, respective valves, and the like.

FIG. 6B is a diagram showing an engine according to an example embodiment of the present invention, and is a perspective view showing the decompression valve, respective valves, and the like.

FIG. 7 is a diagram showing an engine according to an example embodiment of the present invention, and is a perspective view showing a decompression valve in a closed state and a decompression valve advancing/retreating mechanism.

FIG. 8 is a diagram showing an engine according to an example embodiment of the present invention, and is a cross-sectional view showing the decompression valve in the closed state and the decompression valve advancing/retreating mechanism.

FIG. 9 is a diagram showing an engine according to an example embodiment of the present invention, and is a perspective view showing the decompression valve in an open state and the decompression valve advancing/retreating mechanism.

FIG. 10 is a diagram showing an engine according to an example embodiment of the present invention, and is a cross-sectional view showing the decompression valve in the open state and the decompression valve advancing/retreating mechanism.

### DETAILED DESCRIPTION OF THE EXAMPLE EMBODIMENTS

Hereinafter, engines according to example embodiments of the present invention will be described in detail based on the drawings. In the following description, the front-rear direction refers to the direction in which pistons to be described later reciprocate along the axial direction of a cylinder chamber to be described later. The left-right direction refers to the direction in which cylinder spaces to be described later are arranged. Also, the left-right direction is synonymous with the width direction. In the following description, the same members are, in principle, assigned the same reference numerals, and repeated descriptions thereof are omitted. Furthermore, in the present example embodiment, the configurations described in the claims are mainly illustrated and described. Therefore, portions of the engine 10 other than structural elements and features included in example embodiments of the present invention, for example, a crankshaft rotation synchronization mechanism, a lubricating oil supply mechanism, a fuel supply mechanism, electrical components, a drive mechanism to drive respective valves and the like, a belt, and the like, are not illustrated.

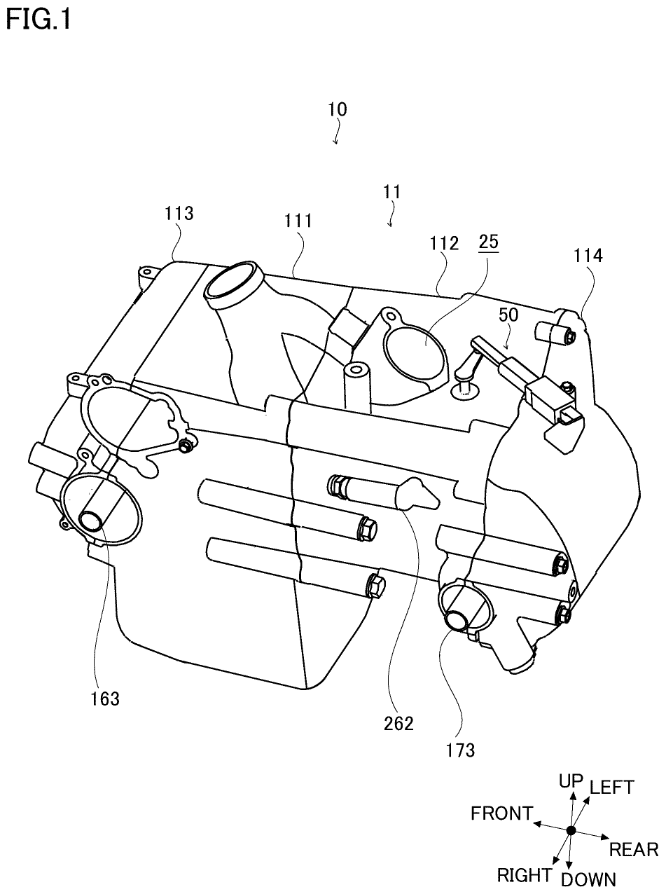

FIG. 1 is a perspective view showing an engine 10 according to an example embodiment of the present invention.

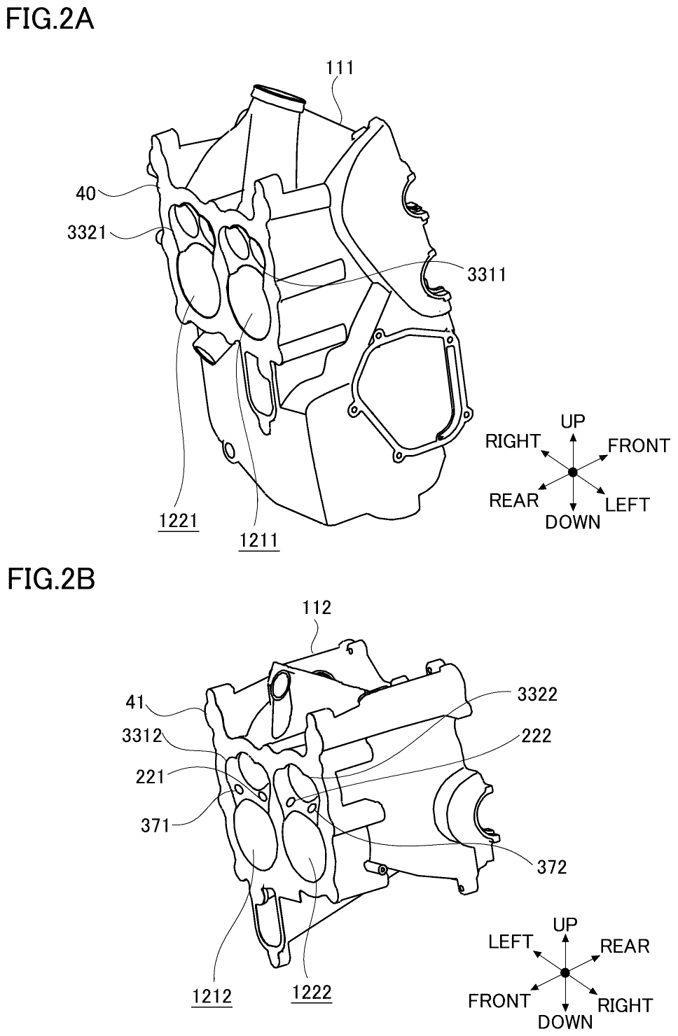

The engine 10 is an opposed-piston engine including a plurality of oppositely arranged pistons. The internal configuration and operation of the engine 10 will be described later with reference to FIG. 2A and subsequent figures.

The engine 10 is configured to be operated with gasoline, diesel oil, hydrogen, or the like as fuel. The engine 10 can be used as a drive source for various devices. The engine 10 is used as a drive source for vehicles, generators, water heaters, flight apparatuses, drones, series hybrid drones, parallel hybrid drones, and the like. A series hybrid drone refers to a drone that operates a generator by the engine 10, rotates a motor by electric power generated from the generator, rotates a rotor by the motor, and levitates an airframe in the air by lift generated by the rotation of the rotor. A parallel hybrid drone refers to a drone that mechanically rotates a main rotor by the engine 10, and levitates an airframe by lift generated by the rotation of the main rotor. The engine 10 of the present example embodiment is an opposed-piston engine, and because it is lightweight and has low vibration, it is particularly suitable as a drive source for series hybrid drones, parallel hybrid drones, and the like.

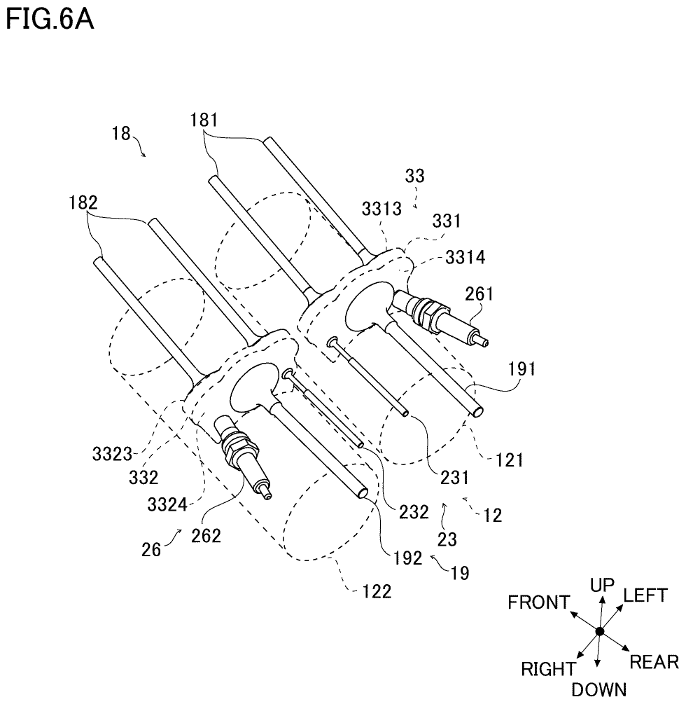

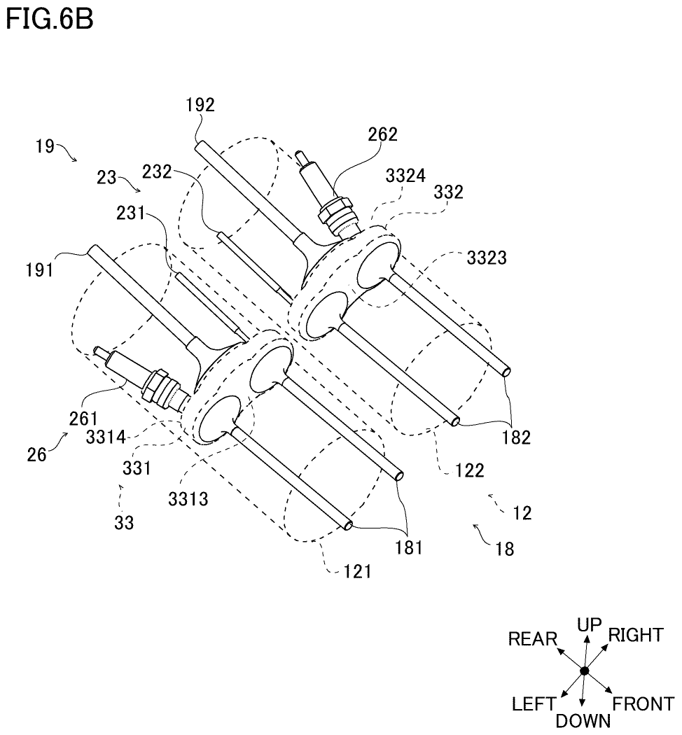

Specifically, the engine 10 may include a cylinder chamber 12, an intake valve 18, and an exhaust valve 19. These respective structural elements of the engine 10 are housed in an engine block 11. The cylinder chamber 12, the intake valve 18, the exhaust valve 19, and the like will be described with reference to FIG. 6A and the like.

Also, the engine 10 includes an engine block 11 that is a main body part. The engine block 11 is made of, for example, a cast aluminum alloy or the like. The engine block 11 includes a first engine block 111, a second engine block 112, a third engine block 113, and a fourth engine block 114. These respective structural elements are fastened to each other by fasteners such as stud bolts (not shown).

On the right side surface of the engine 10, a third crankshaft 163 and a fourth crankshaft 173 are led out. From the third crankshaft 163 and the fourth crankshaft 173, rotational power can be taken out to the outside. Also, a crankshaft can also be led out from the left side surface of the engine 10, and rotational power can also be taken out to the outside from this crankshaft.

Also, a second spark plug 262 is attached to the right side surface of the engine block 11. Similarly, on the left side surface of the engine block 11 also, a first spark plug 261 (not shown here) is attached. The first spark plug 261 and the second spark plug 262 penetrate respective side surface portions of the second engine block 112, and electrodes at their tips are exposed to an extension space 33 to be described later. This configuration will be described later with reference to FIG. 6A and the like. Furthermore, on an upper surface of the engine block 11, an exhaust port 25 is provided. The exhaust port 25 is a path through which gas after combustion inside the engine 10 is discharged.

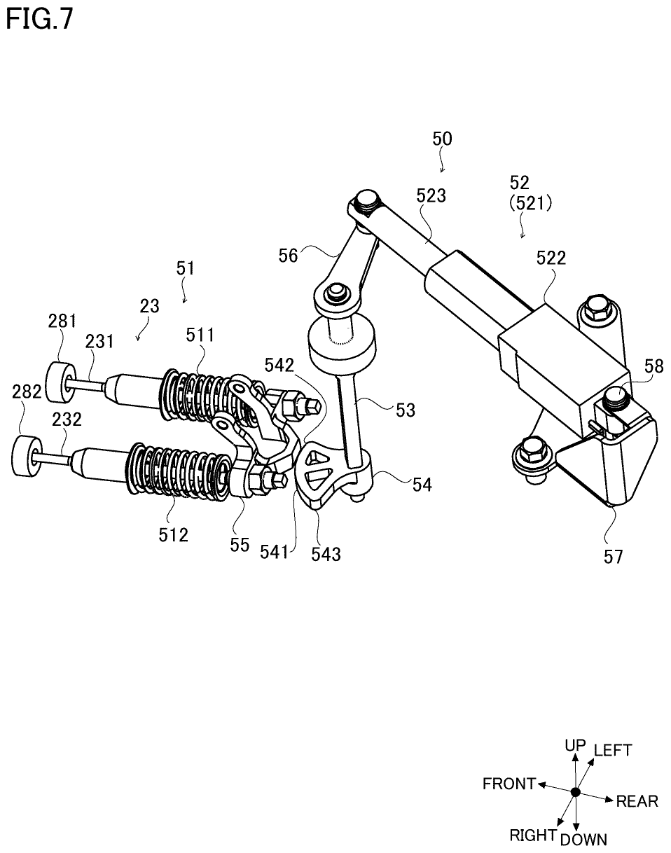

Furthermore, the engine 10 includes a decompression valve advancing/retreating mechanism 50. The decompression valve advancing/retreating mechanism 50 is a mechanism to cause a decompression valve 23, to be described later, to perform an advancing/retreating operation. In FIG. 1, a portion of the decompression valve advancing/retreating mechanism 50 is arranged on the upper surface of the engine block 11. The decompression valve advancing/retreating mechanism 50 will be described later with reference to FIG. 7 and the like.

FIG. 2A is a perspective view showing the first engine block 111.

Referring to FIG. 2A, the surface of the first engine block 111 facing rearward is taken as a first contact surface 40. The first contact surface 40 is a flat surface, and contacts a second contact surface 41 of a second engine block 112 to be described later.

The first engine block 111 includes a first cylinder chamber front portion 1211 and a second cylinder chamber front portion 1221 in a substantially cylindrical shape extending forward from the first contact surface 40. The first cylinder chamber front portion 1211 and the second cylinder chamber front portion 1221 are adjacent along the left-right direction. The first cylinder chamber front portion 1211 is a substantially cylindrical space, and provides a front portion of a first cylinder chamber 121 to be described later. The second cylinder chamber front portion 1221 is a substantially cylindrical space, and provides a front portion of a second cylinder chamber 122 to be described later.

A first extension space front portion 3311 is a portion where the first contact surface 40 is recessed forward, and is continuous with an upper end of the first cylinder chamber front portion 1211. The first extension space front portion 3311 provides a front portion of a first extension space 331 to be described later.

A second extension space front portion 3321 is a portion where the first contact surface 40 is recessed forward, and is continuous with an upper end of the second cylinder chamber front portion 1221. The second extension space front portion 3321 provides a front portion of a second extension space 332 to be described later.

Referring to FIG. 2B, the surface of the second engine block 112 facing forward is taken as a second contact surface 41. The second contact surface 41 is a flat surface, and contacts the first contact surface 40 of the aforementioned first engine block 111.

The second engine block 112 includes a first cylinder chamber rear portion 1212 and a second cylinder chamber rear portion 1222 extending rearward from the second contact surface 41. The first cylinder chamber rear portion 1212 and the second cylinder chamber rear portion 1222 are adjacent along the left-right direction. The first cylinder chamber rear portion 1212 is a substantially cylindrical space, and provides a rear portion of a first cylinder chamber 121 to be described later. The second cylinder chamber rear portion 1222 is a substantially cylindrical space, and provides a rear portion of a second cylinder chamber 122 to be described later.

A first extension space rear portion 3312 is a portion where the second contact surface 41 is recessed rearward, and is continuous with an upper end of the first cylinder chamber rear portion 1212. The first extension space rear portion 3312, together with the aforementioned first extension space front portion 3311, provides a first extension space 331 to be described later.

A second extension space rear portion 3322 is a portion where the second contact surface 41 is recessed rearward, and is continuous with an upper end of the second cylinder chamber rear portion 1222. The second extension space rear portion 3322, together with the aforementioned second extension space front portion 3321, provides a second extension space 332 to be described later.

In the first extension space rear portion 3312, a first plug installation hole 371 and a first decompression valve installation hole 221 are provided. Furthermore, in the second extension space rear portion 3322, a second plug installation hole 372 and a second decompression valve installation hole 222 are provided. A first spark plug 261, to be described later, is installed in the first plug installation hole 371. A first decompression valve 231, to be described later, is installed in the first decompression valve installation hole 221. A second spark plug 262, to be described later, is installed in the second plug installation hole 372. A second decompression valve 232, to be described later, is installed in the second decompression valve installation hole 222.

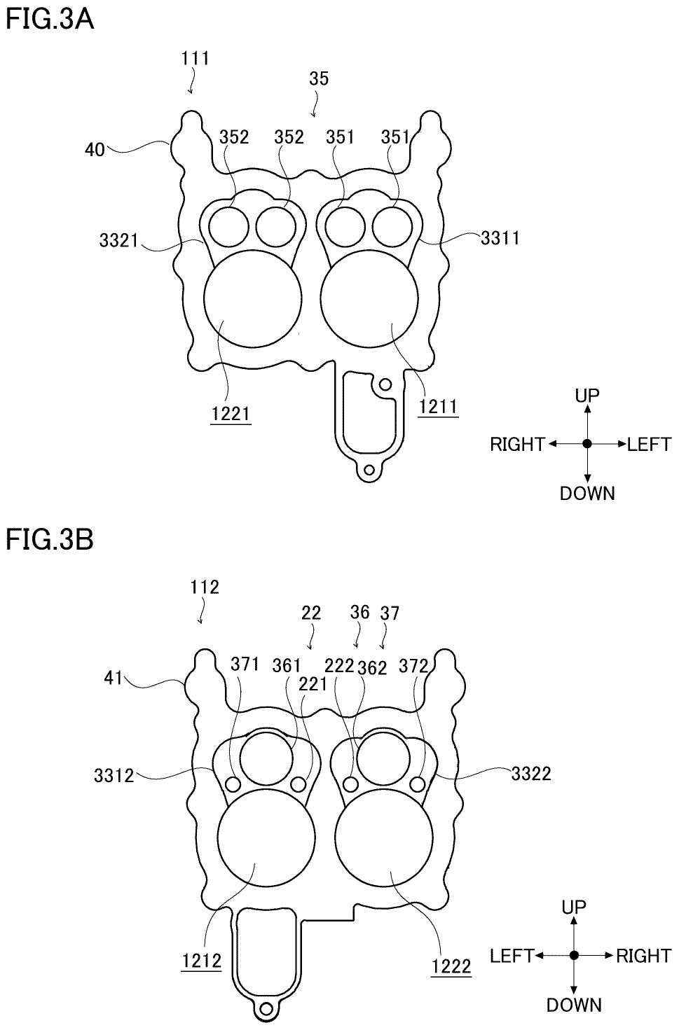

FIG. 3A is a diagram showing the first contact surface 40 of the first engine block 111. Intake valve installation holes 35 are in the first contact surface 40. The intake valve installation holes 35 include first intake valve installation holes 351 and second intake valve installation holes 352.

Two first intake valve installation holes 351 are inside the first extension space front portion 3311. The first intake valve installation holes 351 are through-holes that circularly penetrate a wall portion of the first engine block 111 in the front-rear direction. First intake valves 181, to be described later, are respectively arranged in the first intake valve installation holes 351.

Two second intake valve installation holes 352 are inside the second extension space front portion 3321. The second intake valve installation holes 352 are through-holes that circularly penetrate a wall portion inside the first engine block 111. Second intake valves 182, to be described later, are respectively arranged in the second intake valve installation holes 352.

FIG. 3B is a diagram showing the second contact surface 41 of the second engine block 112. Exhaust valve installation holes 36, plug installation holes 37, and decompression valve installation holes 22 are in the second contact surface 41. The exhaust valve installation holes 36 include a first exhaust valve installation hole 361 and a second exhaust valve installation hole 362. The plug installation holes 37 include a first plug installation hole 371 and a second plug installation hole 372. The decompression valve installation holes 22 are in the engine block 11 in a portion of the extension space 33. Specifically, the decompression valve installation holes 22 include a first decompression valve installation hole 221 and a second decompression valve installation hole 222.

The first exhaust valve installation hole 361 is a hole portion in the first extension space rear portion 3312. The first exhaust valve installation hole 361 circularly penetrates a wall portion inside the second engine block 112. A first exhaust valve 191, to be described later, is arranged in the first exhaust valve installation hole 361.

The first plug installation hole 371 is a through-hole in a lower portion on a left side, which is outward in the width direction, inside the first extension space rear portion 3312. The first plug installation hole 371 is a through-hole that penetrates a left side surface portion of the second engine block 112. A first spark plug 261, to be described later, is installed in the first plug installation hole 371.

The first decompression valve installation hole 221 is a through-hole in a lower portion on a right side, which is inward in the width direction, inside the first extension space rear portion 3312. The first decompression valve installation hole 221 is a hole that penetrates a wall portion inside the second engine block 112. A first decompression valve 231, to be described later, is installed in the first decompression valve installation hole 221.

The second exhaust valve installation hole 362 is a hole portion in the second extension space rear portion 3322. The second exhaust valve installation hole 362 circularly penetrates a wall portion inside the second engine block 112. A second exhaust valve 192, to be described later, is arranged in the second exhaust valve installation hole 362.

The second plug installation hole 372 is a through-hole in a lower portion on a right side, which is outward in the width direction, inside the second extension space rear portion 3322. The second plug installation hole 372 is a through-hole that penetrates a right side surface portion of the second engine block 112. A second spark plug 262, to be described later, is installed in the second plug installation hole 372.

The second decompression valve installation hole 222 is a through-hole in a lower portion on a left side, which is inward in the width direction, inside the second extension space rear portion 3322. The second decompression valve installation hole 222 is a hole that penetrates a wall portion inside the second engine block 112. A second decompression valve 232, to be described later, is installed in the second decompression valve installation hole 222.

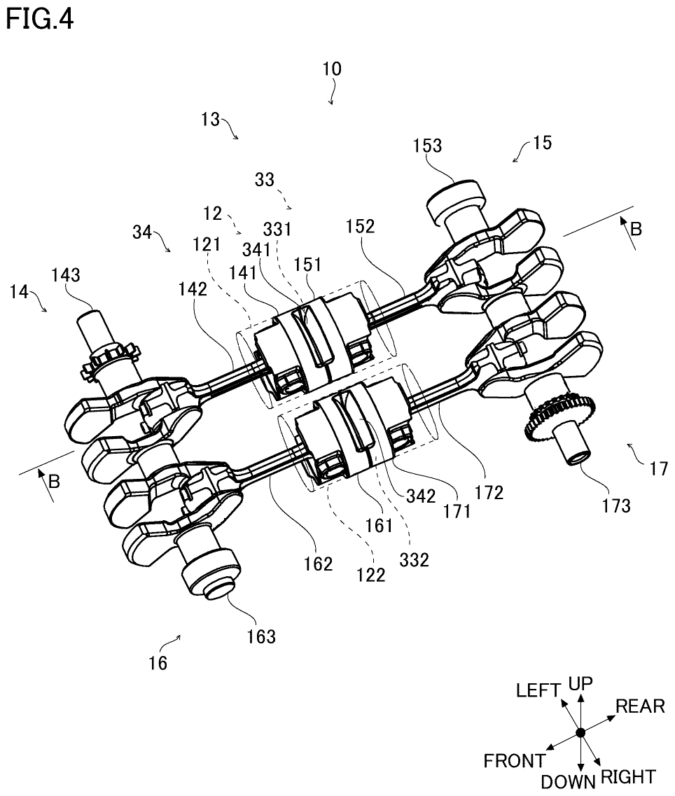

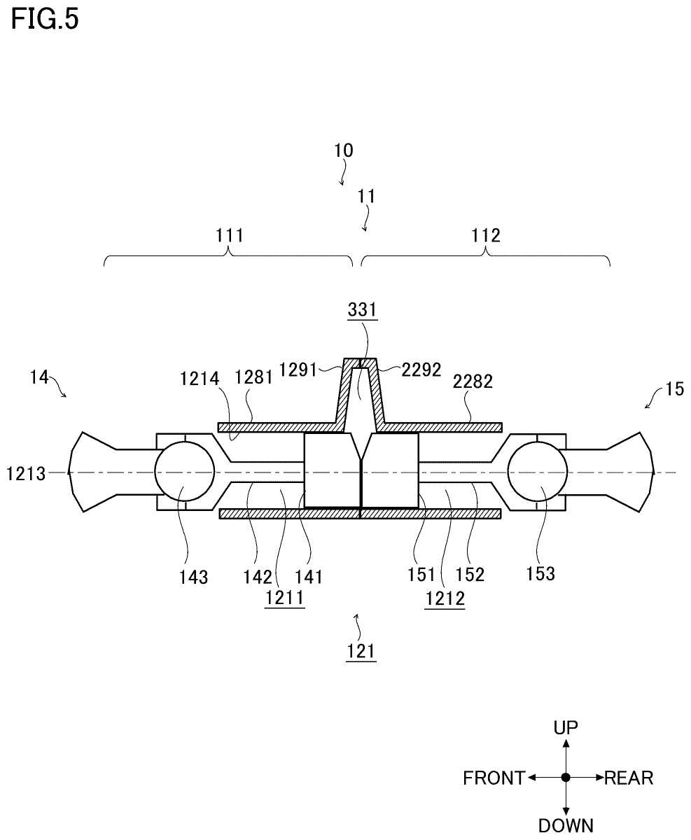

FIG. 4 is a perspective view of an engine unit 13 housed in the aforementioned engine block 11, as viewed from the front.

The engine unit 13 has a first engine portion 14, a second engine portion 15, a third engine portion 16, and a fourth engine portion 17. The first engine portion 14 and the second engine portion 15 define one opposed engine portion. The third engine portion 16 and the fourth engine portion 17 define one opposed engine portion. Because the engine 10 includes a plurality of opposed engine portions, high output can be achieved while ensuring light weight and low vibration of the engine 10.

The cylinder chamber 12 includes a first cylinder chamber 121, and a second cylinder chamber 122 adjacent to the first cylinder chamber 121. The first cylinder chamber 121 and the second cylinder chamber 122 are adjacent along the left-right direction. In FIG. 4, the first cylinder chamber 121 and the second cylinder chamber 122 are indicated by dotted lines. Inside the first cylinder chamber 121, oppositely arranged first piston 141 and second piston 151 are arranged so as to reciprocate. Inside the second cylinder chamber 122, oppositely arranged third piston 161 and fourth piston 171 are arranged so as to reciprocate.

The first engine portion 14 has a first piston 141, a first connecting rod 142, and a first crankshaft 143. The first connecting rod 142 rotatably connects the first piston 141 and the first crankshaft 143.

The second engine portion 15 is arranged so as to oppose the first engine portion 14. The second engine portion 15 has a second piston 151, a second connecting rod 152, and a second crankshaft 153. The second connecting rod 152 rotatably connects the second piston 151 and the second crankshaft 153.

The third engine portion 16 includes a third piston 161, a third connecting rod 162, and a third crankshaft 163. The third connecting rod 162 rotatably connects the third piston 161 and the third crankshaft 163.

The fourth engine portion 17 is arranged so as to oppose the third engine portion 16. The fourth engine portion 17 has a fourth piston 171, a fourth connecting rod 172, and a fourth crankshaft 173. The fourth connecting rod 172 rotatably connects the fourth piston 171 and the fourth crankshaft 173.

The first crankshaft 143 of the first engine portion 14 and the third crankshaft 163 of the third engine portion 16 are integrally continuous. Therefore, the first piston 141 of the first engine portion 14 and the third piston 161 of the third engine portion 16 reciprocate simultaneously.

Similarly, the second crankshaft 153 of the second engine portion 15 and the fourth crankshaft 173 of the fourth engine portion 17 are integrally continuous. Therefore, the second piston 151 of the second crankshaft 153 and the fourth piston 171 of the fourth engine portion 17 reciprocate simultaneously.

The engine unit 13 has a configuration in which an opposed engine portion including the first engine portion 14 and the second engine portion 15, and opposed engine portion including the third engine portion 16 and the fourth engine portion 17 are arranged side by side along the left-right direction. Also, the first engine portion 14 and the third engine portion 16 rotate the first crankshaft 143 and the third crankshaft 163. Furthermore, the second engine portion 15 and the fourth engine portion 17 rotate the second crankshaft 153 and the fourth crankshaft 173. With this configuration, large power can be generated even with a compact configuration.

The extension space 33 is a space extending upward, which is a lateral direction, from an intermediate portion of the cylinder chamber 12 in the front-rear direction. The extension space 33 includes a first extension space 331 and a second extension space 332. The first extension space 331 is a space extending upward from an intermediate portion in the front-rear direction of the first cylinder chamber 121. The second extension space 332 is a space extending upward from an intermediate portion in the front-rear direction of the second cylinder chamber 122. The first extension space 331 and the second extension space 332 are portions where respective valves and plugs are installed, as will be described later. The specific shape and the like of the extension space 33 are shown in FIG. 6A and the like.

A combustion chamber 34 is a space sandwiched by pistons inside the cylinder chamber 12. The combustion chamber 34 includes a first combustion chamber 341 and a second combustion chamber 342. The first combustion chamber 341 is a space inside the first cylinder chamber 121, sandwiched by the first piston 141 and the second piston 151, where an air-fuel mixture combusts. The first combustion chamber 341 is continuous with the first extension space 331. The second combustion chamber 342 is a space inside the second cylinder chamber 122, sandwiched by the third piston 161 and the fourth piston 171, where an air-fuel mixture combusts. The second combustion chamber 342 is continuous with the second extension space 332.

FIG. 5 is a cross-sectional view along the line B-B in FIG. 4, and shows a wall portion of the engine block 11 that defines the first cylinder chamber 121 and the first extension space 331.

As described above, the first cylinder chamber 121 is a space having a substantially cylindrical shape. The first cylinder chamber 121 includes a first cylinder chamber front portion 1211 on a front side, and a first cylinder chamber rear portion 1212 connected to a rear end of the first cylinder chamber front portion 1211. At a substantially central portion in the front-rear direction of the first cylinder chamber 121, the first extension space 331 projects upward from an upper surface of the first cylinder chamber 121. The first cylinder chamber front portion 1211, the first cylinder chamber rear portion 1212, and the first extension space 331 communicate with each other.

The first cylinder chamber 121 and the first extension space 331 of such a configuration are spaces surrounded by a wall portion inside the engine block 11.

Specifically, the first cylinder chamber front portion 1211 is a substantially cylindrical space surrounded by a first cylinder wall portion 1281. The first cylinder wall portion 1281 is a tubular wall inside the first engine block 111. A front end and a rear end of the first cylinder wall portion 1281 are in an open state.

The first cylinder chamber rear portion 1212 is a substantially cylindrical space surrounded by a second cylinder wall portion 2282. The second cylinder wall portion 2282 is a tubular wall inside the second engine block 112. A front end and a rear end of the second cylinder wall portion 2282 are in an open state.

The first extension space 331 is a space surrounded by a first extension wall portion 1291 and a second extension wall portion 2292. The first extension wall portion 1291 is a substantially tongue-shaped portion extending upward from an upper end portion of the first cylinder wall portion 1281 at a rear end of the first cylinder wall portion 1281. The second extension wall portion 2292 is a substantially tongue-shaped portion extending upward from an upper end portion of the second cylinder wall portion 2282 at a front end of the second cylinder wall portion 2282.

The first cylinder chamber 121 is a substantially cylindrical space having a first central axis 1213 extending along the front-rear direction. The first cylinder chamber 121 includes a first side surface 1214. The first side surface 1214 is a surface including inner surfaces of the first cylinder wall portion 1281 and the second cylinder wall portion 2282. The first extension space 331 extends from the first side surface 1214. Specifically, the first extension space 331 is a space extending upward, which is a direction orthogonal to the first central axis 1213 of the first cylinder chamber 121. The first extension space 331 communicates with the first cylinder chamber 121.

Such matters are also similar with respect to the aforementioned second cylinder chamber 122.

FIG. 6A is a perspective view showing the cylinder chamber 12, respective valves, and the like from an upper rear right side. FIG. 6B is a perspective view showing the cylinder chamber 12, respective valves, and the like from an upper front left side.

The extension space 33 is connected to the cylinder chamber 12, and is a space that serves as a starting point of combustion in a combustion stroke to be described later. Specifically, the extension space 33 is a space extending continuously upward from a central portion in the front-rear direction of the cylinder chamber 12. As the extension space 33, a first extension space 331 is in the first cylinder chamber 121, and a second extension space 332 is in the second cylinder chamber 122.

The first extension space 331 is a substantially tongue-shaped portion having a largest surface facing in the front-rear direction. The first extension space 331 includes a first side surface 3313 and a second side surface 3314. The first side surface 3313 is a surface facing forward. The second side surface 3314 is a surface facing rearward.

The second extension space 332 is a substantially tongue-shaped portion including a largest surface facing in the front-rear direction. The second extension space 332 includes a first side surface 3323 and a second side surface 3324. The first side surface 3323 is a surface facing forward. The second side surface 3324 is a surface facing rearward.

The intake valve 18 includes a first intake valve 181 and a second intake valve 182.

The first intake valve 181 is configured to advance and retreat with respect to the first side surface 3313 of the first extension space 331 from a front side. Here, two first intake valves 181 are provided. The first intake valves 181 are respectively attached to the first intake valve installation holes 351 shown in FIG. 3A. The first intake valve 181 is configured to intake an air-fuel mixture into the first cylinder chamber 121. By the first intake valve 181 entering the first extension space 331, the first intake valve installation hole 351 shown in FIG. 3A is opened, and intake into the first extension space 331 and the first cylinder chamber 121 can be performed. On the other hand, by the first intake valve 181 retreating from the first extension space 331, the first intake valve installation hole 351 shown in FIG. 3A is closed.

The second intake valve 182 is configured to advance and retreat with respect to the first side surface 3323 of the second extension space 332 from a front side. Here, two second intake valves 182 are provided. The second intake valves 182 are respectively attached to the second intake valve installation holes 352 shown in FIG. 3A. The second intake valve 182 is configured to intake an air-fuel mixture into the second cylinder chamber 122. By the second intake valve 182 entering the second extension space 332, the second intake valve installation hole 352 shown in FIG. 3A is opened, and intake into the second extension space 332 and the second cylinder chamber 122 can be performed. On the other hand, by the second intake valve 182 retreating from the second extension space 332, the second intake valve installation hole 352 shown in FIG. 3A is closed.

The exhaust valve 19 includes a first exhaust valve 191 and a second exhaust valve 192.

The first exhaust valve 191 is configured to advance and retreat with respect to the second side surface 3314 of the first extension space 331 from a rear side. Here, one first exhaust valve 191 is provided. The first exhaust valve 191 is attached to the first exhaust valve installation hole 361 shown in FIG. 3B. The first exhaust valve 191 is configured to exhaust gas after combustion from the first cylinder chamber 121. By the first exhaust valve 191 entering the first extension space 331, the first exhaust valve installation hole 361 shown in FIG. 3B is opened, and exhaust from inside the first cylinder chamber 121 via the first exhaust valve installation hole 361 can be performed. On the other hand, by the first exhaust valve 191 retreating from the first extension space 331, the first exhaust valve installation hole 361 shown in FIG. 3B is closed.

The second exhaust valve 192 is configured to advance and retreat with respect to the second side surface 3324 of the second extension space 332 from a rear side. Here, one second exhaust valve 192 is provided. The second exhaust valve 192 is attached to the second exhaust valve installation hole 362 shown in FIG. 3B. The second exhaust valve 192 is configured to exhaust gas after combustion from the second cylinder chamber 122. By the second exhaust valve 192 entering the second extension space 332, the second exhaust valve installation hole 362 shown in FIG. 3B is opened, and exhaust from inside the second cylinder chamber 122 via the second exhaust valve installation hole 362 can be performed. On the other hand, by the second exhaust valve 192 retreating from the second extension space 332, the second exhaust valve installation hole 362 shown in FIG. 3B is closed.

The number of intake valves 18 is greater than the number of exhaust valves 19. For example, regarding the first extension space 331, the number of first exhaust valves 191 is one, and the number of first intake valves 181 is two. By doing so, by the first spark plug 261 being exposed to the extension space 33 from the side of the first exhaust valve 191, which is fewer in number, the space around the first extension space 331 can be used effectively.

The spark plug 26 is arranged on the side where the exhaust valve 19 is provided, that is, on a rear side of the extension space 33. An electrode at a tip of the spark plug 26 is arranged inside the extension space 33. The spark plug 26 includes a first spark plug 261 and a second spark plug 262.

The first spark plug 261 is arranged on a left side of the first exhaust valve 191. A front end portion of the first spark plug 261 penetrates the second side surface 3314, and is arranged inside the first extension space 331.

The second spark plug 262 is arranged on a right side of the second exhaust valve 192. A front end portion of the second spark plug 262 penetrates the second side surface 3324, and is arranged inside the second extension space 332.

The decompression valve 23 is a valve that, in an initial stage of operation of the engine 10, performs decompression to improve startability of the engine 10 by bringing the extension space 33 into communication with the outside to release pressure in the cylinder chamber 12. The decompression valve 23 includes a first decompression valve 231 and a second decompression valve 232. The first decompression valve 231 faces the first extension space 331 from the second side surface 3314. The second decompression valve 232 faces the second extension space 332 from the second side surface 3324. The operation of the first decompression valve 231 and the second decompression valve 232 will be described later with reference to FIG. 7 and subsequent figures.

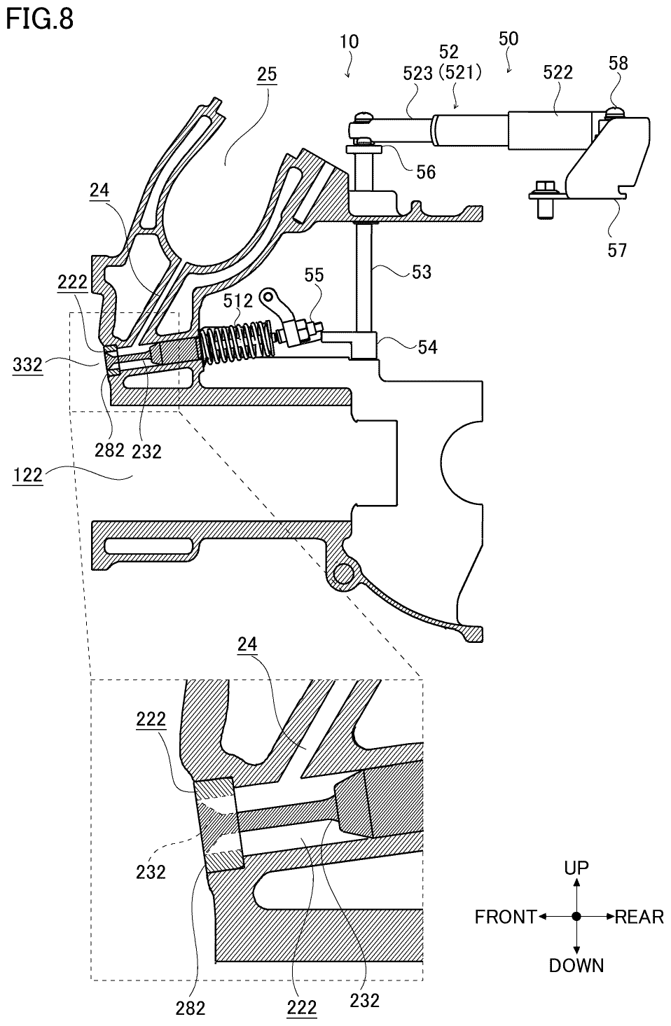

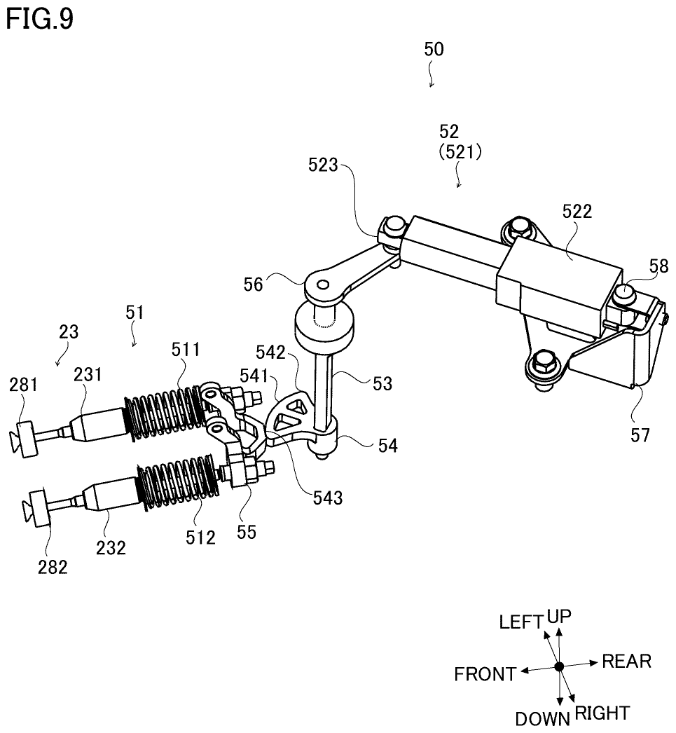

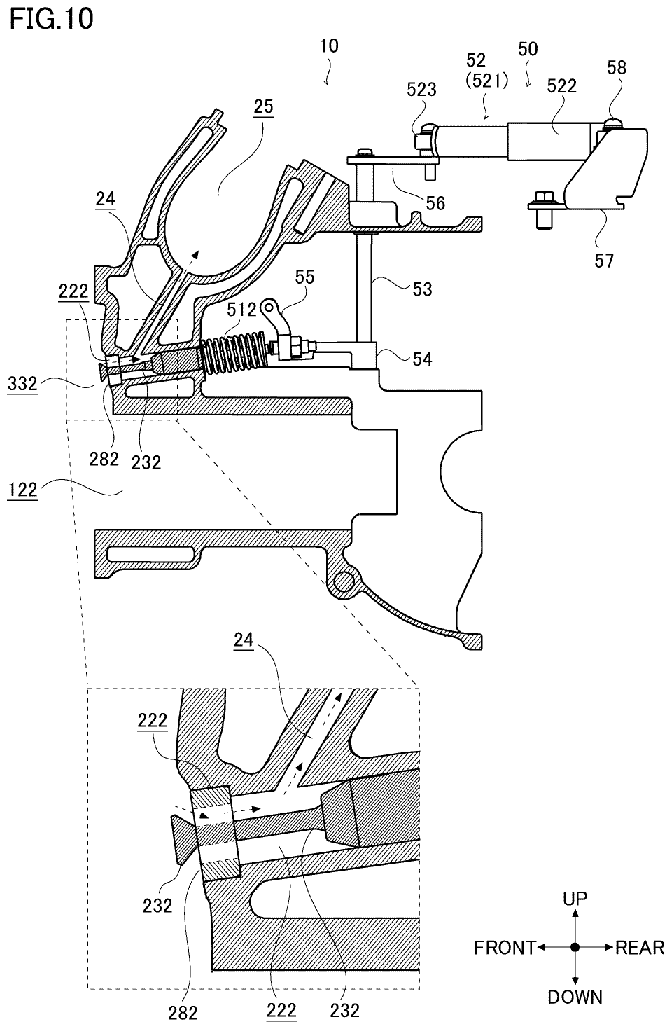

The configuration and operation of the decompression valve advancing/retreating mechanism 50 will be described with reference to FIG. 7 to FIG. 10. FIG. 7 is a perspective view showing the decompression valve 23 in a closed state and the decompression valve advancing/retreating mechanism 50. FIG. 8 is a cross-sectional view showing the decompression valve 23 in the closed state and the decompression valve advancing/retreating mechanism 50. FIG. 9 is a perspective view showing the decompression valve 23 in an open state and the decompression valve advancing/retreating mechanism 50. FIG. 10 is a cross-sectional view showing the decompression valve 23 in the open state and the decompression valve advancing/retreating mechanism 50.

The configuration of the decompression valve advancing/retreating mechanism 50 will be described with reference to FIG. 7. FIG. 7 is a perspective view showing the decompression valve advancing/retreating mechanism 50 when the decompression valve 23 is in the closed state.

As described above, the decompression valve advancing/retreating mechanism 50 is a mechanism configured to advance and retreat the decompression valve 23. Specifically, the decompression valve advancing/retreating mechanism 50 may include a spring 51, an actuator 52, a shaft 53, a cam 54, and a rocker arm 55.

The actuator 52 is, for example, a linear actuator 521. The linear actuator 521 is configured to be capable of linear reciprocating motion. The linear actuator 521 has a fixed portion 522 and an extension portion 523. With a motor or the like housed in the fixed portion 522 as a drive source, the extension portion 523 extends and retracts with respect to the fixed portion 522. A rear side end portion of the fixed portion 522 is attached to an upper surface of the engine block 11 shown in FIG. 1 via a bracket 57. Also, the rear side end portion of the fixed portion 522 is attached to an upper surface of the bracket 57 by a connecting portion 58. In the connecting portion 58, the fixed portion 522 of the linear actuator 521 is made rotatable. By doing so, as will be described later, linear extension/retraction motion of the linear actuator 521 can be converted into rotational motion of the cam 54.

An arm 56 is a plate-shaped structure, and is arranged between the linear actuator 521 and the shaft 53. A left side end portion of the arm 56 is rotatably connected to a front side end portion of the extension portion 523. A right side end portion of the arm 56 is connected to an upper end side end portion of the shaft 53 so as to be relatively non-rotatable.

The shaft 53 is a substantially rod-shaped structure extending linearly along an up-down direction. As described above, the arm 56 is connected to an upper end portion of the shaft 53 so as to be relatively non-rotatable. The cam 54 is connected to a lower end portion of the shaft 53 so as to be relatively non-rotatable.

The cam 54 is a structure that, when viewed from above, has a substantially fan shape with a portion connected to the shaft 53 as a starting point. The shape of the cam 54 when viewed from above has an irregular fan shape. That is, the cam 54 includes a side surface portion 541 facing radially outward. When the cam 54 is viewed from above, the side surface portion 541 includes a first side surface end portion 542, which is an end portion on one side, and a second side surface end portion 543, which is an end portion on the other side. Here, the first side surface end portion 542 is closer to a rotation center of the shaft 53, that is, a connecting portion between the cam 54 and the shaft 53, than the second side surface end portion 543. Also, the side surface portion 541 of the cam 54 contacts a rear end of the rocker arm 55. As will be described later, by the cam 54 having such a shape, a pressing amount and pressing force to press the rocker arm 55 forward can be adjusted by rotating the cam 54.

The rocker arm 55 is made of a bent metal plate or the like. A left side end portion of the rocker arm 55 connects to a rear end of the first decompression valve 231. A right side end portion of the rocker arm 55 connects to a rear end of the second decompression valve 232. An intermediate portion of the rocker arm 55 projects rearward and contacts the side surface portion 541 of the cam 54. The rocker arm 55 is arranged so as to swing in the front-rear direction with an upper end as a rotation center.

The spring 51 is configured to apply an urging force to the decompression valve 23. The spring 51 includes a first spring 511 and a second spring 512.

A rear portion of the first decompression valve 231 is inserted into the first spring 511, and the first spring 511 is arranged to apply a rearward urging force to the first decompression valve 231. The first decompression valve 231 closes a first valve seat ring 281 by being urged by the first spring 511.

A rear portion of the second decompression valve 232 is inserted into the second spring 512, and the second spring 512 is arranged to apply a rearward urging force to the second decompression valve 232. The second decompression valve 232 closes a second valve seat ring 282 by being urged by the second spring 512.

The first valve seat ring 281 is a substantially ring-shaped structure press-fitted from the inside into the first decompression valve installation hole 221 shown in FIG. 3B. A front end portion of the first decompression valve 231 is inserted into the first valve seat ring 281. By the front end portion of the first decompression valve 231 closing the first valve seat ring 281, the aforementioned first extension space 331 and first cylinder chamber 121 are not decompressed. On the other hand, by the front end portion of the first decompression valve 231 being pushed out to a front side of the first valve seat ring 281, a gap is located between the first decompression valve 231 and the first valve seat ring 281, and via this gap, the aforementioned first extension space 331 and first cylinder chamber 121 are decompressed.

The second valve seat ring 282 is a substantially ring-shaped structure press-fitted from the inside into the second decompression valve installation hole 222 shown in FIG. 3B. A front end portion of the second decompression valve 232 is inserted into the second valve seat ring 282. By the front end portion of the second decompression valve 232 closing the second valve seat ring 282, the aforementioned second extension space 332 and second cylinder chamber 122 are not decompressed. On the other hand, by the front end portion of the second decompression valve 232 being pushed out to a front side of the second valve seat ring 282, a gap is located between the second decompression valve 232 and the second valve seat ring 282, and via this gap, the aforementioned second extension space 332 and second cylinder chamber 122 are decompressed.

In the state shown in FIG. 7, that is, in a state where decompression is not performed, the decompression valve advancing/retreating mechanism 50 does not strongly press the first decompression valve 231 and the second decompression valve 232. For this reason, due to rearward urging force of the first spring 511 and the second spring 512, the first decompression valve 231 and the second decompression valve 232 close the first valve seat ring 281 and the second valve seat ring 282.

Specifically, based on an instruction from an arithmetic control unit, which is a CPU (not shown), the linear actuator 521 enters an extended state. Then, the front side end portion of the extension portion 523 pushes the left side end portion of the arm 56 forward. Thus, the arm 56, the shaft 53, and the cam 54 rotate counterclockwise when viewed from above, with a central axis of the shaft 53 as a rotation center. Thus, the side surface portion 541 in the vicinity of the first side surface end portion 542 contacts the rear end of the rocker arm 55. As described above, the side surface portion 541 in the vicinity of the first side surface end portion 542 is close to the rotation center of the cam 54. Therefore, the pressing amount and pressing force applied by the cam 54 to the rocker arm 55 become small. For this reason, the first decompression valve 231 and the second decompression valve 232 are urged rearward by the first spring 511 and the second spring 512, and close openings of the first valve seat ring 281 and the second valve seat ring 282. Thus, the aforementioned decompression is not performed. During normal operation of the engine 10, the decompression valve 23 is closed in this manner.

FIG. 8 is a partial cross-section of the engine 10 when the second decompression valve 232 is in the closed state.

The second decompression valve installation hole 222 is a through-hole that penetrates an inner wall of the engine 10 along the front-rear direction. Also, a ventilation hole 24 extending from an intermediate portion of the second decompression valve installation hole 222 toward the exhaust port 25 is provided. The ventilation hole 24 is a through-hole that linearly penetrates a thick-walled portion inside the engine 10. The ventilation hole 24 is a path through which an air-fuel mixture passing from the first cylinder chamber 121 and the first extension space 331 to the exhaust port 25 passes during decompression. The ventilation hole 24 also corresponds to the aforementioned first decompression valve installation hole 221.

When the pressing force and pressing amount applied by the decompression valve advancing/retreating mechanism 50 to the second decompression valve 232 are small, the second decompression valve 232 is arranged on a rear side by an urging force of the second spring 512. Therefore, the front end portion of the second decompression valve 232 closes the second valve seat ring 282. Thus, the second extension space 332 and the second cylinder chamber 122 enter a state of normal operation of the engine 10, that is, a non-decompressed state. That is, gas inside the second cylinder chamber 122 and the second extension space 332 does not escape to the outside via the second decompression valve installation hole 222 and the ventilation hole 24.

FIG. 9 illustrates a state of the decompression valve advancing/retreating mechanism 50 when the decompression valve 23 is in an open state (decompression state).

The operation of the decompression valve advancing/retreating mechanism 50 when changing the decompression valve 23 from the closed state to the open state will be described. First, based on an instruction from an arithmetic control unit (not shown here), the linear actuator 521 enters a contracted state. That is, due to driving force of a motor housed in the fixed portion 522, most of the extension portion 523 is drawn into the fixed portion 522. Then, the left side end portion of the arm 56 is drawn rearward. As a result, the arm 56, the shaft 53, and the cam 54 rotate clockwise, with a central axis of the shaft 53 extending along the up-down direction as a rotation center. Simultaneously, the linear actuator 521 rotates counterclockwise when viewed from above, with the connecting portion 58 as a rotation center. When this rotation ends, the second side surface end portion 543 of the cam 54 abuts the rear end of the rocker arm 55. As described above, the shape of the cam 54 in a plan view is not an accurate fan shape. The second side surface end portion 543 is farther from the central axis of the shaft 53 than the first side surface end portion 542. Therefore, when the second side surface end portion 543 of the cam 54 abuts the rocker arm 55, the first decompression valve 231 and the second decompression valve 232 are pushed out forward. Then, a front end portion of the first decompression valve 231 projects forward from a front end of the first valve seat ring 281. Thus, a gap for decompression is located between the first decompression valve 231 and the first valve seat ring 281. Similarly, a front end portion of the second decompression valve 232 projects forward from a front end portion of the second valve seat ring 282. Thus, a gap for decompression is located between the second decompression valve 232 and the second valve seat ring 282.

FIG. 10 is a cross-section of the engine 10 when the second decompression valve 232 is in the open state. Here, the flow of gas during decompression is indicated by dotted arrows.

As described above, in the decompression valve advancing/retreating mechanism 50, by the linear actuator 521 performing a contracting operation, a front end of the second decompression valve 232 projects forward from a front surface of the second valve seat ring 282. Thus, a gap for decompression is located between the second decompression valve 232 and the second valve seat ring 282. During decompression, gas inside the second cylinder chamber 122 and the second extension space 332 enters the second decompression valve installation hole 222 from the gap between the second decompression valve 232 and the second valve seat ring 282, and thereafter, passes through the ventilation hole 24 and is discharged to the exhaust port 25.

Such matters are also similar with respect to the first decompression valve 231 and the first valve seat ring 281 shown in FIG. 9. That is, the first decompression valve 231 simultaneously brings the first valve seat ring 281 into an open state and a closed state with the second decompression valve 232.

The operation of the decompression valve advancing/retreating mechanism 50 is controlled by an arithmetic control unit. The arithmetic control unit is configured or programmed to control the operation of the actuator 52 based on an input signal input from a rotation sensor that senses a rotation speed of the engine 10.

Specifically, when the rotation speed of the engine 10 is equal to or less than a predetermined rotation speed, that is, in an initial stage of operation of the engine 10, the decompression valve advancing/retreating mechanism 50, as shown in FIG. 10, presses the second decompression valve 232 forward, thereby bringing the second cylinder chamber 122 and the second extension space 332 into communication with the outside and lowering the pressure.

Thereafter, when the rotation speed of the engine 10 exceeds the predetermined rotation speed, that is, when the initial stage of operation of the engine 10 ends, the decompression valve advancing/retreating mechanism 50, as shown in FIG. 8, does not press the second decompression valve 232 forward to close the second cylinder chamber 122 and the second extension space 332. Thus, the engine 10 enters a normal operating state.

Hereinafter, a normal operating operation of the engine 10 will be described. The first engine portion 14 and the second engine portion 15 of the engine unit 13 of the above-described configuration operate by repeating an intake stroke, a compression stroke, a combustion stroke, and an exhaust stroke as follows.

In the intake stroke, referring to FIG. 4, by the first piston 141 and the second piston 151 moving from a central portion toward an outer side inside the first cylinder chamber 121, an air-fuel mixture, which is a mixture of fuel and air, is sucked into the first cylinder chamber 121. Simultaneously, the first crankshaft 143 and the second crankshaft 153 rotate. Referring to FIG. 6A and FIG. 6B, in the intake stroke, the first intake valve 181 brings the first extension space 331 into an open state, while the first exhaust valve 191 brings the first extension space 331 into a closed state. Therefore, the air-fuel mixture can be sucked into the first cylinder chamber 121 via the first intake valve installation hole 351 and the first extension space 331 shown in FIG. 3A.

In the compression stroke, referring to FIG. 4, due to inertia of the rotating first crankshaft 143 and second crankshaft 153, the first piston 141 and the second piston 151 are pushed out toward the central portion, and the air-fuel mixture is compressed inside the first cylinder chamber 121. Referring to FIG. 6A, the first intake valve 181 brings the first extension space 331 into a closed state, and the first exhaust valve 191 brings the first extension space 331 into a closed state. Therefore, the first extension space 331 and the first cylinder chamber 121 enter a closed state, and the air-fuel mixture can be compressed inside the first cylinder chamber 121.

In the combustion stroke, by the first spark plug 261 shown in FIG. 6A igniting in the first extension space 331, the air-fuel mixture combusts inside the first extension space 331 and the first cylinder chamber 121 shown in FIG. 4, and thus, the first piston 141 and the second piston 151 are pushed out to an outer end portion, which is a bottom dead center. Referring to FIG. 6A, similarly to the compression stroke, in this stroke, the first intake valve 181 brings the first extension space 331 into a closed state, and the first exhaust valve 191 brings the first extension space 331 into a closed state. That is, the states of the first intake valve 181 and the first exhaust valve 191 are similar to the aforementioned compression stroke.

In the exhaust stroke, referring to FIG. 4, due to inertia of the rotating first crankshaft 143 and second crankshaft 153, the first piston 141 and the second piston 151 are pushed inward, and gas after combustion existing inside the first cylinder chamber 121 is discharged to the outside. Referring to FIG. 6A and FIG. 6B, the first intake valve 181 brings the first extension space 331 into a closed state, while the first exhaust valve 191 brings the first extension space 331 into an open state. Thus, the gas after combustion inside the first cylinder chamber 121 is released to the outside from the first exhaust valve installation hole 361 shown in FIG. 3B.

Such operation is also similar with respect to the third engine portion 16, the fourth engine portion 17, the second intake valve 182, and the second exhaust valve 192.

In the engine unit 13 according to the present example embodiment, the stroke can be divided by the two pistons, the first piston 141 and the second piston 151, that reciprocate inside one first cylinder chamber 121. Therefore, compared to a normal engine, the compression ratio of the mixed gas can be increased. Also, because the first piston 141 and the second piston 151 oppose each other inside the first cylinder chamber 121, a cylinder head required in a general engine becomes unnecessary, and the configuration of the engine unit 13 is simple and lightweight. Also, respective structural elements of the engine unit 13, that is, the first piston 141 and the second piston 151, the first crankshaft 143 and the second crankshaft 153, and the like, are arranged opposing each other, and operate so as to oppose each other. From this, vibrations generated from the respective structures of the engine unit 13 are cancelled out, and vibrations generated to the outside from the entire engine unit 13 can be reduced. Therefore, by mounting the engine unit 13 having such a structure on a flight apparatus, miniaturization, weight reduction, and low vibration of the flight apparatus can be achieved. In particular, by reducing vibration, adverse effects on arithmetic control devices such as attitude control and motor output control, and precision instruments such as GPS sensors can be prevented. Also, it is possible to prevent delivery cargo transported by the flight apparatus from being damaged by vibration.

Although the example embodiments of the present invention have been described above, the present invention is not limited thereto, and modifications can be made without departing from the gist of the present invention. Also, the structural elements or features of the example embodiments described above can be combined with each other.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An engine comprising:
an engine block;
a cylinder chamber inside the engine block;
an extension space inside the engine block and extending outward from the cylinder chamber;
a decompression valve installation hole in the engine block in a portion of the extension space;
a decompression valve arranged to advance and retreat with respect to the decompression valve installation hole;
a decompression valve advancing/retreating mechanism to cause the decompression valve to perform an advancing/retreating operation;
a first engine portion; and
a second engine portion; wherein
the first engine portion includes a first piston, a first connecting rod, and a first crankshaft;
the second engine portion includes a second piston, a second connecting rod, and a second crankshaft;
the first piston and the second piston oppose each other inside the cylinder chamber;
the extension space extends from a portion of the cylinder chamber sandwiched by the first piston and the second piston, in a direction orthogonal to a direction in which the first piston and the second piston reciprocate;
the decompression valve advancing/retreating mechanism includes a spring and an actuator;
the spring is arranged to urge the decompression valve to close the decompression valve installation hole; and
the actuator is arranged to urge the decompression valve to open the decompression valve installation hole.

2. The engine according to claim 1, wherein
the cylinder chamber includes a first cylinder chamber and a second cylinder chamber;
the extension space includes a first extension space in the first cylinder chamber and a second extension space in the second cylinder chamber;
the decompression valve installation hole includes a first decompression valve installation hole in the engine block in a portion of the first extension space and a second decompression valve installation hole in the engine block in a portion of the second extension space;
the decompression valve includes a first decompression valve arranged to advance and retreat with respect to the first decompression valve installation hole and a second decompression valve arranged to advance and retreat with respect to the second decompression valve installation hole;
the spring includes a first spring arranged to apply an urging force to the first decompression valve and a second spring arranged to apply an urging force to the second decompression valve;
the first decompression valve closes the first decompression valve installation hole by being urged by the first spring, and opens the first decompression valve installation hole by being pressed by the actuator; and
the second decompression valve closes the second decompression valve installation hole by being urged by the second spring, and opens the second decompression valve installation hole by being pressed by the actuator.

3. The engine according to claim 2, wherein the decompression valve advancing/retreating mechanism includes a shaft rotatable by the actuator, a cam connected to the shaft so as to be relatively non-rotatable, and a rocker arm to rotate by abutting the cam, and a first side of the rocker arm abuts the cam and a second side of the rocker arm abuts the first decompression valve and the second decompression valve.

4. The engine according to claim 3, wherein the actuator is a linear actuator.
